(19) United States
(12) Patent Application Publication
(10) Pub. No.: US 2022/0177018 A1
(43) Pub. Date: Jun. 9, 2022

(54) Motorized Folding All-Terrain Wagon

(71) Applicant: Walter Parubrub, San Jose, CA (US)

(72) Inventor: Walter Parubrub, San Jose, CA (US)

(21) Appl. No.: 16/993,203

(22) Filed: Aug. 13, 2020

(51) Int. Cl. B62B 3/00; B62B 3/02; B62B 5/00

(52) U.S. Cl. CPC B62B 3/007; B62B 3/02; B62B 5/0036; B62B 5/0053; B62B 5/0069

(57) ABSTRACT

The present invention comprises of a motorized folding all-terrain wagon that can fit in an automobile. The preferred embodiment having the front wheels controlled by a steering linkage attached to the handle. Large treaded wheels powered by electric motor(s) with drive assemblies, motor controller, battery, control buttons, switches and/or control panel. Optional embodiment is to have a braking system.

### FIELD OF THE INVENTION

The present invention relates wagons to transport general items or equipment from one location to another. More particularly, wagons that are motorized.

### BACKGROUND

In general, wagons or carts are used for carrying or transporting multiple, heavy or bulky items from location to another. Wagons consists of having a cargo-hold or basket to store or carry items, wheels or tracks to traverse over various surfaces or terrains and handle(s) aid in directionally pushing or pulling the wagon to the destination. The cargo-hold or basket of the wagon commonly has a bottom section and walls or liners made of metal, wood, plastic, fabric, or combinations of materials.

Users have difficulty pulling a non-motorized and heavily loaded wagon, when traversing soft or rough terrains and elevation changes.

Folding wagons have small wheels that will bury in soft terrains such as sand or grass, or easily catch in rough or rocky terrain when the wagon is loaded with heavy items, producing a lot of pulling effort by the user.

Wagons that do not have synchronous and directional steering, such as castor wheels, are difficult to turn when the wagon is loaded with heavy items and in soft or rough terrain.

Motorized wagons in the current market are not small, portable and light enough to be stored and transported within an automobile.

Presently there is no wagon that that is portable to be stored in the trunk or inside of a car, and light and simple enough to be easily deployed, and when loaded with heavy items, have the versatility to traverse a multitude of terrains and elevations and direction with very little effort and much control by the user.

### BRIEF SUMMARY OF THE INVENTION

The present invention seeks to provide a solution to the problems by providing a lightweight, and motorized folding wagon that fits and can be transported in an automobile. The wagon has large wheels with treaded tires, controlled steering and controlled motor propulsion(s) and braking, to allow transport of heavy loads on a variety of terrains and elevation changes, enabling high control of the wagon and little pulling effort by the user.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective of the unfolded/deployed invention.

FIG. 2 depicts a rear perspective of the unfolded/deployed invention with single motor, single drive assembly and axle configuration.

FIG. 3 depicts a rear perspective of the unfolded/deployed invention with single motor, dual drive assembly and axle configuration.

FIG. 4 depicts a rear perspective of the unfolded/deployed invention with dual motor, dual drive assembly and no axle configuration.

FIG. 5 depicts a rear perspective of the folded invention with single motor, single drive assembly and axle configuration.

FIG. 6 depicts a rear perspective of the folded invention with single motor, dual drive assembly and axle configuration.

FIG. 7 depicts a rear perspective of the folded invention with dual motor, dual drive assembly and no axle configuration.

### DETAILED DESCRIPTION AND BEST MODE OF IMPLEMENTATION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

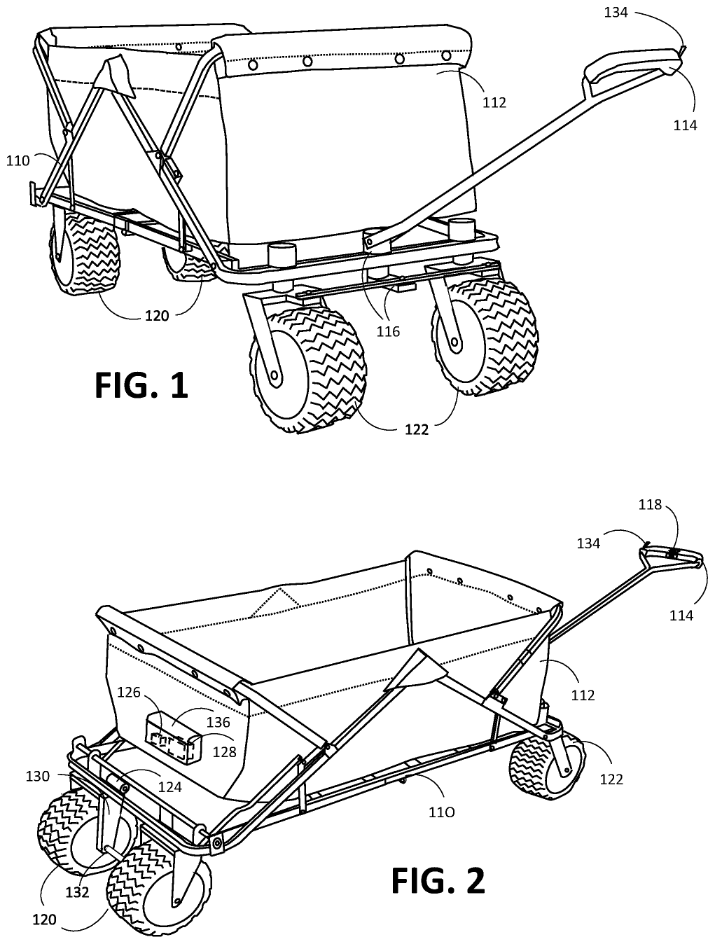

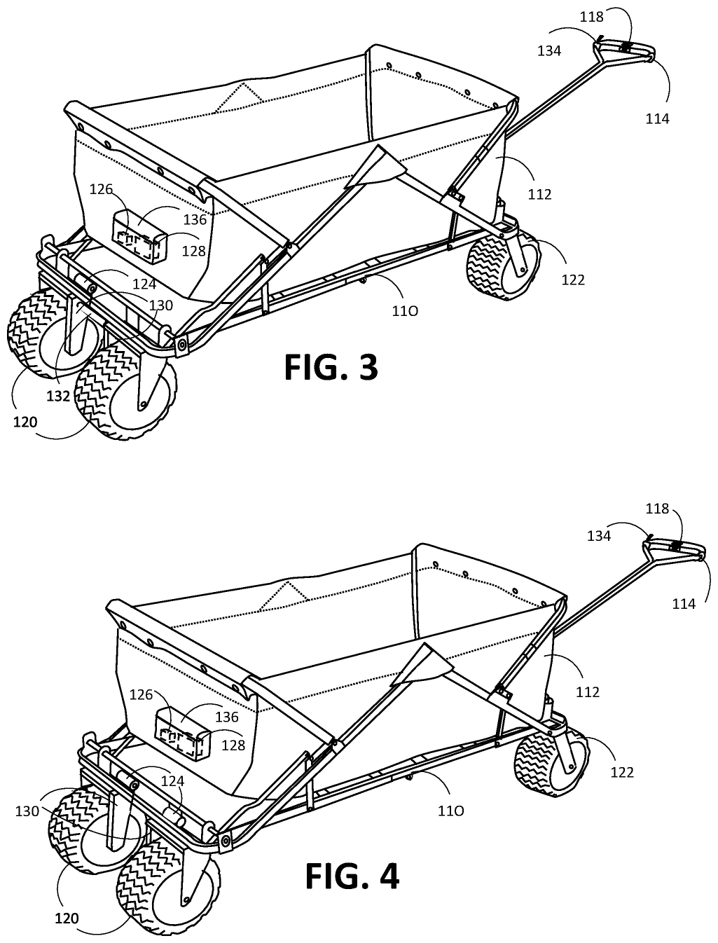

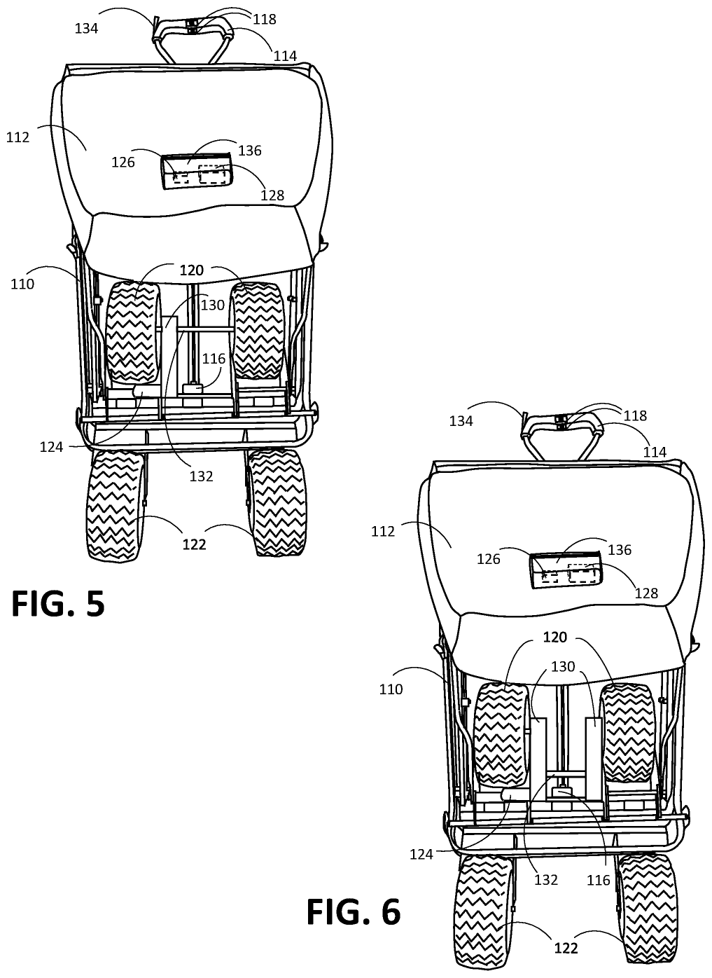

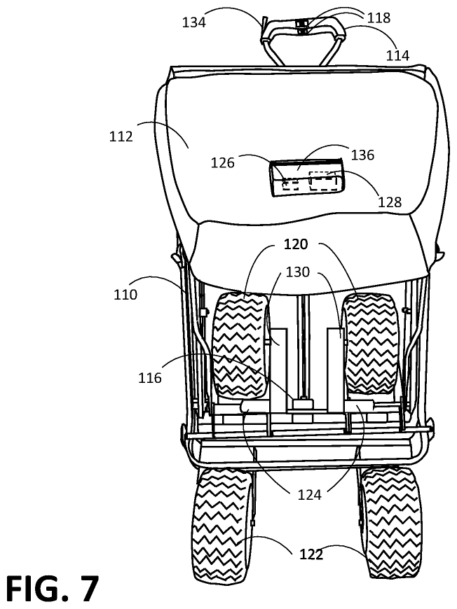

The basket 112 has soft sides and bottom sections and fits onto the folding frame 110. The basket 112 is preferably made, but not limited to, woven fabric. The folding frame 110 is preferably made of, but not limited to, aluminum, steel, or plastic. The preferred folding configuration is depicted, but not limited to, FIG. 1, FIG. 2, FIG. 3, FIG. 4, FIG. 5, FIG. 6, and FIG. 7.

The handle 114 connects to the steering linkage assembly 116, and the steering linkage assembly 116 connects to the folding frame 110, and the steering linkage assembly connects to the front wheels 122. The steering linkage assembly 116 is preferably made of, but not limited to, aluminum or steel. The linkage assembly 116 is preferably configured, but not limited to, synchronized swivels above each wheel.

The motor 124 connects to the drive assembly 130, and the drive assembly 130 connects to the rear wheels 120. The preferable dual motor configuration depicted in FIG. 4 and FIG. 7, but not limited to, a dedicated motor 124 connecting to drive assembly 130 connecting to a single rear wheel 120, no axle. Single motor configuration options, but not limited to, are depicted in FIG. 2, FIG. 3, FIG. 5, and FIG. 6, utilizing a single motor 124 connecting to drive assembly 130 in conjunction with axle 132 to connect to wheel 120. Preferable design, but not limited to, is the use of large wheels 120 with large tire treads.

The motor controller 126 connects to the battery 128 and connects to the motor(s) 124 and connects to the motor control buttons/switches 118. The motor controller 126 and battery 128 are preferably, but not limited to, housing in the basket compartment 136.

The motor control buttons/switches 118 configuration preference, but not limited to, fitting into the handle 114. Options are wired or wireless controls.

Brakes can be optional. The brake control 134 is connected to a braking system and applied to the front wheels 122 and/or rear wheels 120. The brake control 134 configuration preference, but not limited to, fitting onto the handle 114. Brake control 134 configuration options can be wired or wireless controls and applied via the motor, drive system or directly to the wheels.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

What is claimed:

1. A wagon with electric motor(s), motor control, steering control, directional control, optional brake system, wheels with the ability to traverse a variety of terrains, and having a compact size to be transportable inside an automobile

2. The wagon of claim 1 further comprising of a collapsing basket having soft sides and bottom sections fitting onto a folding frame.

3. The wagon of claim 1 further comprising of a pull handle connecting to the steering linkage assembly that connects to the folding frame; and front wheels.

4. The wagon of claim 1 further comprises of motor(s) with or without a drive assembly to directionally rotate the wagon wheels.

5. The wagon wheels of claim 4 further comprising of wide wheels with large treads.

6. The motor(s) of claim 4 to have wired or wireless speed and directional controllers.

7. The motors(s) of claim 4 to be electrically powered.

8. The motor controls of claim 5 to have control buttons, switches, screen and/or panel positioned on or near the pull handle of claim 3

9. The motor controllers control buttons, switches, screen and/or panel of claim 8 to control the speed, direction and electrical power.

10. The optional brakes of claim 1 can be activated via the motor, drive system, or directly applied to the wheels.
